(19) United States
(12) Patent Application Publication
(10) Pub. No.: US 2013/0211882 A1
(43) Pub. Date: Aug. 15, 2013

(54) SYSTEMS AND METHODS FOR PROJECT DOCUMENTATION AND PROPOSALS

(71) Applicant: Appostle Concepts, LLC, (US)

(72) Inventor: Samuel Kaleb Brashear, Austin, TX (US)

(73) Assignee: APPOSTLE CONCEPTS, LLC, Austin, TX (US)

(21) Appl. No.: 13/725,232

(22) Filed: Dec. 21, 2012

Related U.S. Application Data
(60) Provisional application No. 61/579,425, filed on Dec. 22, 2011.

(51) Int. Cl. G06Q 10/06

(52) U.S. Cl. CPC G06Q 10/0637
USPC 705/7.36

(57) ABSTRACT

A system and method for providing low voltage project documentation and proposals, including functionalities of completing the entire project in a timely, cost effective fashion. The project manager is concerned with a project from the cradle to the grave, and the entire life cycle of a project, including cost and benefits from initial planning through operations and disposal of a project are relevant to decision making. By integrating project management tools in a manner consistent with optimizing the entire project life cycle, the user is able to access a turn-key solution for onsite take-off and proposal delivery. Each user will be able to utilize the system for the entire process of bidding, designing, tracking and on-site purchase from the project start to finish, all within one system.

### CROSS REFERENCE TO RELATED APPLICATION

This application claims the priority of US Provisional Application Ser. No. 61/579,425, entitled “SYSTEMS AND METHODS FOR PROJECT DOCUMENTATION AND PROPOSALS” and filed on Dec. 22, 2012.

### FIELD

This disclosure relates in general to the field of project management and more particularly to a system and method for generating and managing estimation projects.

### DESCRIPTION OF THE RELATED ART

Project managers and estimators have always sought tools to assist in increasing the efficiency of creating estimates for clients. In project management, accurate and timely estimates are the basis for sound project planning.

Many tools have been developed to aid project managers and estimators, including estimation processes and estimation software. However, few tools offer the user the full functionalities of completing the entire project in a timely, cost effective fashion. The project manager is concerned with a project from the cradle to the grave, and the entire life cycle of a project, including cost and benefits from initial planning through operations and disposal of a project are relevant to decision making.

Currently, there are various tools on the market for project management, including enterprise level software and mobile applications, for creating blueprints or technologies for solving design problems within existing spaces. One such tool was born out of the problem of a common problem for online home buyers and sellers, the inability to grasp the layout and therefore the flow of a property. It was often the case that photos of property interiors were simply not adequate for providing property details. This tool was built to allow generation of floor plans and attachment to an online listing so that buyers may more easily visualize themselves within the property. It further allowed general contractors to create and save blueprints in a straightforward and efficient manner.

In the field of architecture and interior design, there are tools that enable mobile creation of floor plans and arrangement of furniture. The tool allows the addition of furniture and paint or wall paper to each room, playing with layouts and different looks. It also allows for 3D viewing and the virtual walking through the rooms of a property.

However, the above-mentioned approaches have shortcomings. More particularly, other solutions are not integrated in a manner consistent with project management that optimizes the entire project life cycle. Optimizing performance at one stage of the process may not be beneficial overall if additional costs or delays occur elsewhere. For example, saving money on the design process will be a false economy if the result is excess construction or maintenance costs. Further, there is often fragmentation of project management among different specialists. This may be necessary, but good communication and coordination among the participants is essential to accomplish the overall goals of the project.

Additionally, even though current options may introduce new materials and automate processes, they are only desirable to the extent that they are less expensive and are consistent with desired performance. Of utmost importance and value is the ability to improve productivity, an aspect that is often lost in the push for features. One solution allows for the creation of a single floor plan, but each project is limited to one room and does not allow for the building of an entire property's floor plan.

Most estimates last between twenty to forty minutes, and the estimation user will need to communicate with their clients while using an estimation tool. The interface must be simple enough to use while attention is divided between floor plan data generation and talking to clients. Current solutions allow for editing and creation of blueprints and DWG files, but there are no solutions tailed to the low voltage industry.

The above-mentioned approaches may be impractical models that do not allow for project managers to engage clients and contractors in meaningful communication regarding projects in an efficient and economical way nor do they permit project management that results in the quality of work and performance that are critically important to the success of a project.

### SUMMARY

The following disclosure presents concepts for improving utility of product management and creating of estimates for clients. The disclosed subject matter significantly improves upon prior art aimed at providing a tool for arranging floor plans and space planning. It is an object of the present disclosure to permit estimators to either import and annotate an existing diagram or to create a floor plan using drawing features.

The present disclosure teaches a technology enabled tool for mobile creation of estimates that may be readily conveyed to both clients and contractors.

One aspect of the disclosed subject matter is the ability for users to communicate project details to interested parties, including mobile communications and specialized extranets.

Another aspect of the disclosed subject matter is the ability by which users are able to seamlessly place project data into the floor plan.

Yet another aspect of the disclosed subject matter is a toolset capable of mobile execution, enabling in the field deployment.

Another aspect of the disclosed subject matter is the ability of users and project managers to create rooms of any shape and dimension.

Yet another aspect of the disclosed subject matter is the ability to incorporate various floor levels into the project.

Another aspect of the disclosed subject matter is importing of floor plans or creation of a new one from scratch.

Yet another aspect of the disclosed subject matter is the importing of images for floor plan generation.

Another aspect of the disclosed subject matter is freehand sketch tools for creation of objects and layers.

Yet another aspect of the disclosed subject matter is drag and drop features in conjunction with list and menu selection, for the placing of project elements.

Another aspect of the disclosed subject matter is drawing wire grids for assisting the user.

Yet another aspect of the disclosed subject matter is the ability to produce and export turn-key proposals in real time.

Another aspect of the disclosed subject matter is production of full proposals with contracts enabling an electronic signature for acceptance.

Yet another aspect of the disclosed subject matter is on-site payment functions for proposal acceptance via merchant accounts or credit cards.

Another aspect of the disclosed subject matter is tracking and reporting of sales and proposal data through enterprise level software.

Yet another aspect of the disclosed subject matter is multiple user access.

Another aspect of the disclosed subject matter is enablement of users to photograph job sites and implement them within proposals.

Yet another aspect of the disclosed subject matter is enablement of users to photograph job sites and convey them to project management for installation considerations.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the claims.

### BRIEF DESCRIPTIONS OF THE DRAWINGS

The novel features believed characteristic of the presently disclosed subject matter will be set forth in the accompanying claims and any filed later. The presently disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1A illustrates an exemplary embodiment of the present disclosure's project management and selection functionalities (screenshot).

FIG. 1B further illustrates a management capability, enabling a user to remove existing projects (screenshot).

FIG. 2 further illustrates a management capability, enabling a user to add a new project (screenshot).

FIG. 3 portrays tools and features of an exemplary embodiment of the present disclosure (screenshot).

FIG. 4A illustrates another management capability, enabling a user to import floor plans (screenshot).

FIG. 4B shows another management capability, enabling a user to overwrite floor plans (screenshot).

FIGS. 5A, 5B, 5C, and 5D depict draw tools available to the user (screenshots).

FIGS. 6A and 6B show exemplary general dimension tools (screenshot).

FIG. 7 shows an exemplary overlay on how project managers can handle multiple floors (screenshot).

FIG. 8 depicts a management interface for creating settings of various project elements (screenshot).

FIGS. 9 illustrates another management capability of enabling various project views (screenshot).

FIG. 10 shows exemplary symbols and accessories as taught within the current disclosure (screenshot).

FIG. 11 depicts how annotations may be applied to various symbols (screenshot).

FIG. 12 illustrates a quick bid summary of the project (screenshot).

FIG. 13 depicts the communication functionalities as taught within the current disclosure (screenshot).

### DETAILED DESCRIPTION OF THE SPECIFIC EMBODIMENTS

Although described with particular reference to project estimation, particularly low voltage equipment estimation, those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

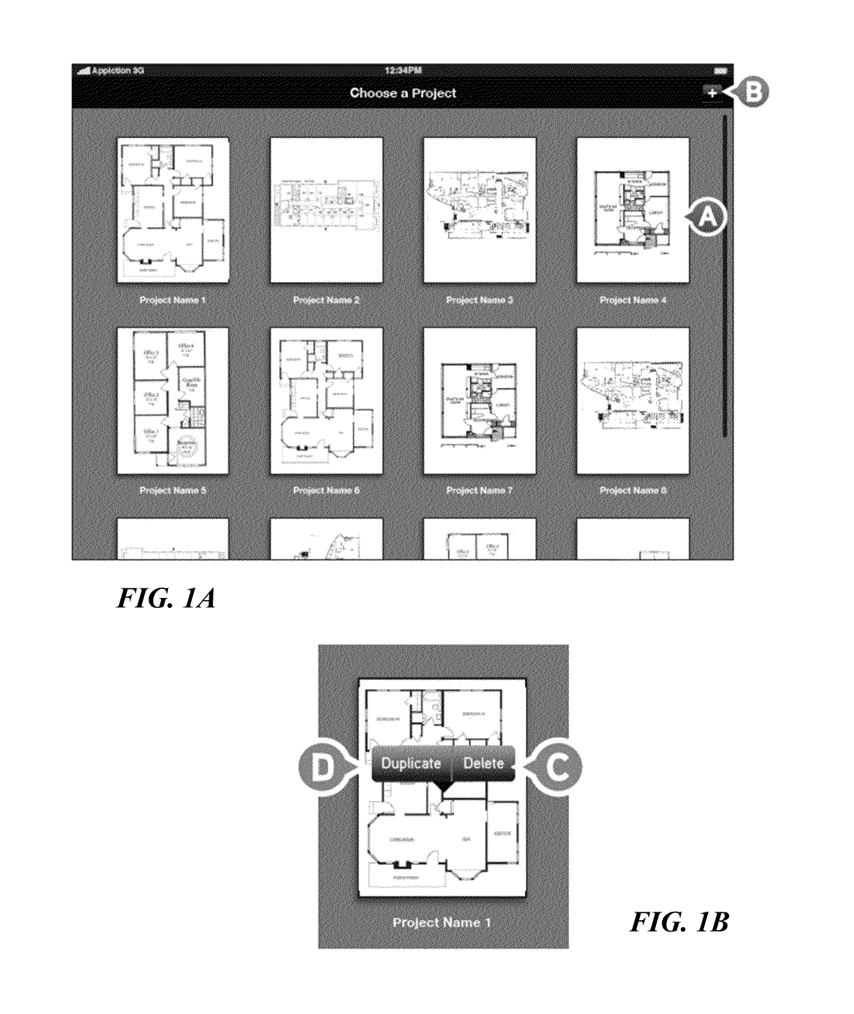

FIG. 1A illustrates an exemplary embodiment of the present disclosure's project management and selection functionalities. The user may import and annotate any existing diagrams or create floor plans using provided drawing tools. Further, any user estimating a job will be able to use this to generate a list of materials required for the project and review any notes, including photos, captured to create an estimate for the project. Along with the ability to add new projects, the user may quickly access currently ongoing projects by selecting their corresponding thumbnails. Tapping and holding a project file will bring up extra action menus, enabling further project management capabilities.

FIG. 1B further illustrates a management capability, enabling a user to remove existing projects. The user may either remove an existing project from the management tool or create a duplicate copy. Duplicate copies may be used for various other projects as a base or for creating multiple estimates for one project client.

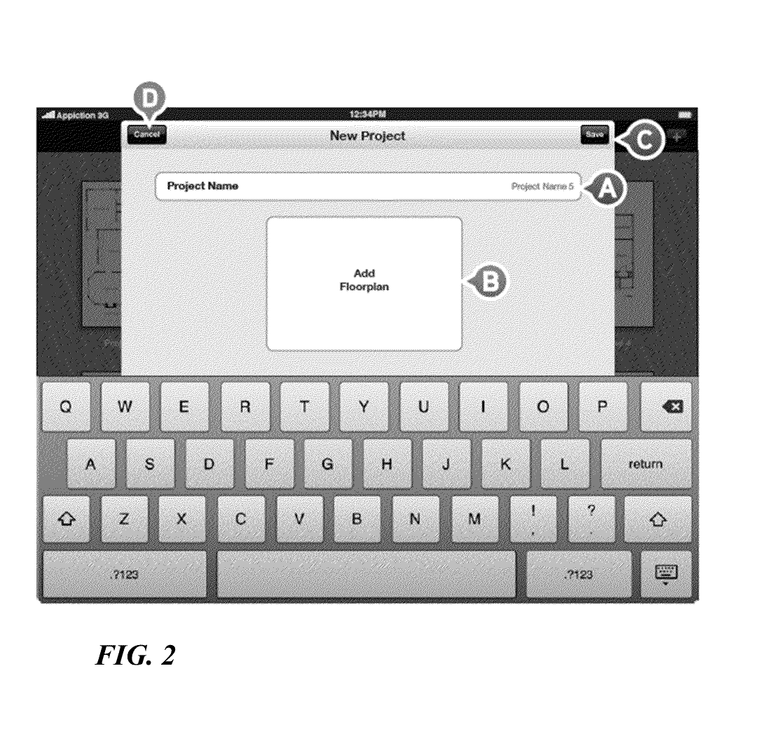

FIG. 2 further illustrates a management capability, enabling a user to add a new project. As previously discussed, after a project is named, the user may choose a floor plan to work with, including but is not limited to: importing from a photo library, selecting a pre-existing project floor plan, photos taken concurrently with a built-in image capture device, or drawing of a new floor plan with provided tools. This will create a workspace for the project, and is further enabled by allowing the user to add or edit floor plans after creating an estimation project.

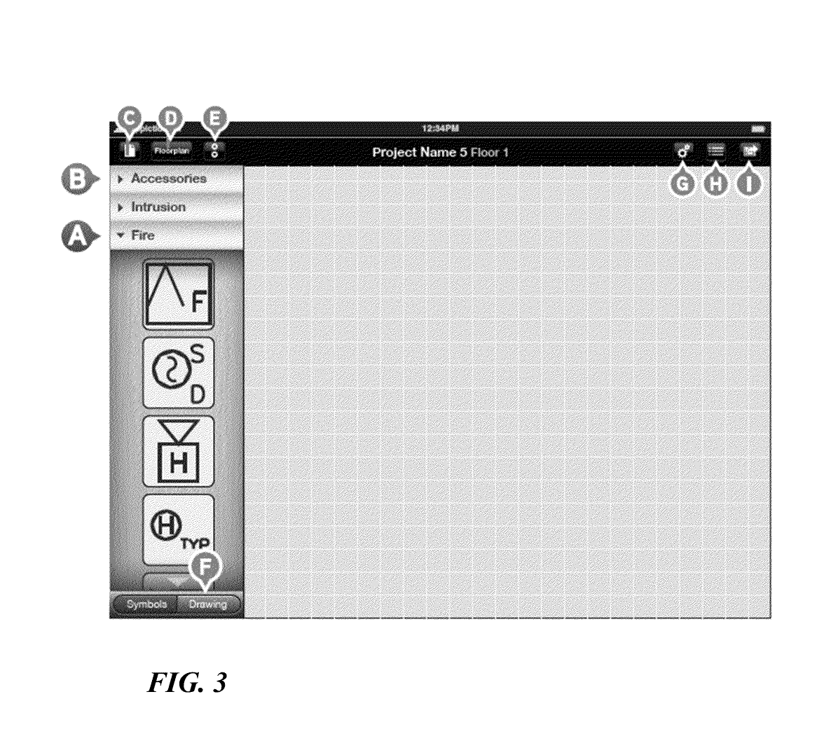

FIG. 3 portrays tools and features of an exemplary embodiment of the present disclosure. Users have various capabilities, including, but is not limited to: adjusting of drawings, sketching floor plans, changing project settings, and accessing drag and drop symbols or accessories. If the user is opening a previously existing project, their workplace will look the same as before it was closed, thereby eliminating the need to continuously save a project for fear of losing created content.

The present disclosure illustrates six categories: intrusion, fire, CCTV, access control, network, and home automation. Exemplary symbols under the intrusion category may include, but is not limited to: contacts, sensors, control panels, keypads, and sirens. Exemplary symbols under the fire category may include, but is not limited to: panel, initiating, enunciators, siren, and detectors. Exemplary symbols under the CCTV category may include, but is not limited to: cameras, DVR/NVR, mounts, lenses, monitors, and storage. Exemplary symbols under the access control category may include, but is not limited to: readers, controllers, software, locks, and egress devices. Exemplary symbols under the network category may include, but is not limited to: router, modem, hub, and data outlets. Exemplary symbols under the home automation category may include, but is not limited to: audio, lights, modules, mounts, keypad, panel, and video.

Further, there are universal project elements which may include, but is not limited to: cables, wires, connectors, power supplies, and various other low voltage equipment and associated accessories.

By selecting the categories, users will be able to access a symbol library of these project elements which may then be dragged and dropped onto the project floor plan. Accessories include various features of a home floor plan, and include, but are not limited to, doors and windows. The user again is able to access predefined accessories features to add to their project floor plan.

Projects may have multiple floors or levels that need to be kept within the same project data folder. Multiple floors may be stored in the same project, and then easily accessed as required by selecting its accompanying floor icon. With a draw tool, notes and sketches may be made on the project floor plan. If one is currently unavailable, this tool could be used to sketch a room or plan. This draw tool further encompasses a background grid that aids in the scaling and drawing of project floor plans.

Within the project settings, the user may select only the categories which will be displayed within the bid summary and the project plan. This is similar to layering systems found in other drafting tools and is useful when the user only needs to export certain project details. The bid summary further details a list of equipment and their quantities. Lastly, the present disclosure teaches an option to export the project plan and bid summary with estimates in multiple formats.

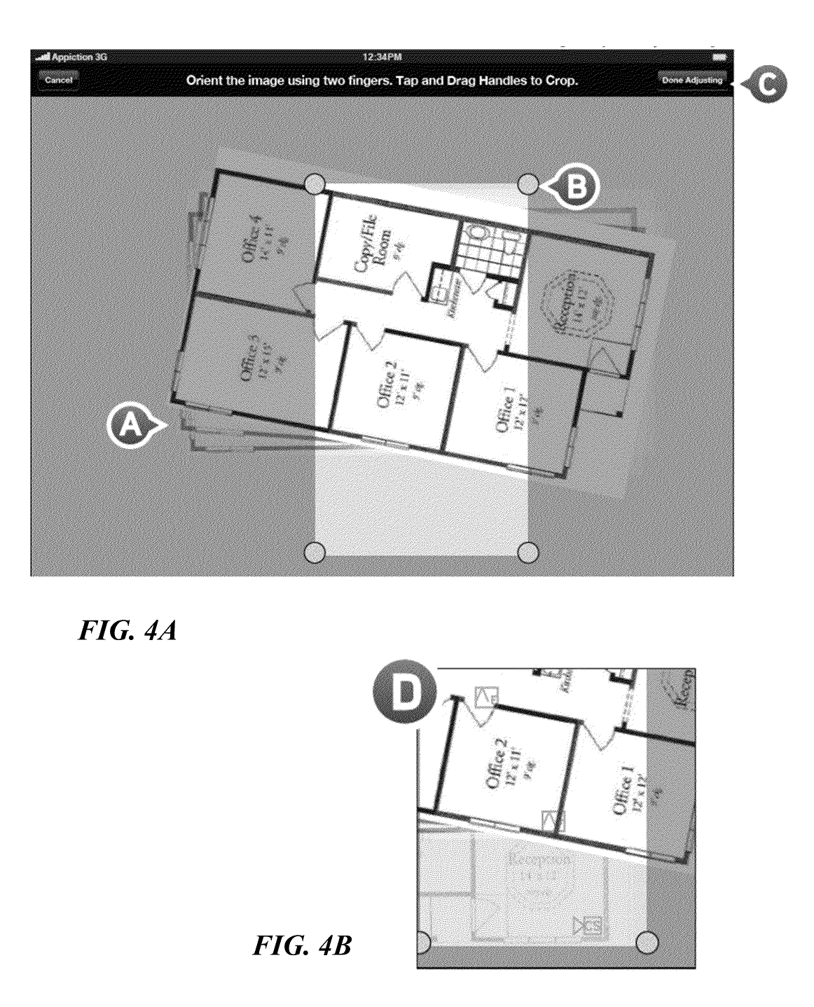

FIG. 4A illustrates a previously discussed management capability, enabling a user to import floor plans. Floor plans may be imported from a preexisting photo library, for example an iPad's photo library. Alternatively, a photo of a hard copy can be taken with a mobile device's camera or with any other photo capture device. These photos may be supplied in any format, including, but is not limited to: JPEG, BMP, GIF, TIFF, or PNG.

After selecting an image for the floor plan, the user will be able to orient and crop the image. When importing a floor plan, the image will be shown in its entirety, but the user has the option to rotate floor plans, scaling them as necessary, or cropping certain parts out. By selecting the bounded areas, the user has the option of selecting which areas of the image the project area will encompass.

FIG. 4B shows another management capability, enabling a user to overwrite floor plans. If the user is overwriting an existing floor plan, the original plan and symbols will be visible while adjusting. The original image may be transparent behind the new image, while the visible symbols will remain on top of the new image. In this way, if the user receives a new version of a floor plan, the user may update their project workspace without having to create a new project file. After orienting the new floor plan, the original image may be removed.

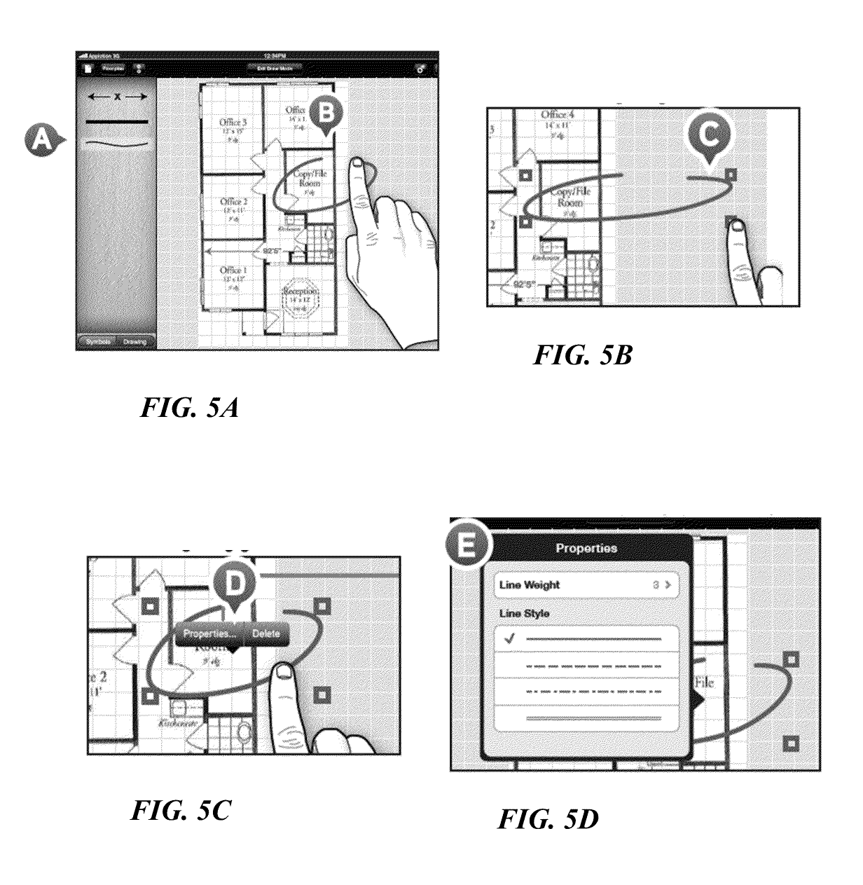

FIGS. 5A, 5B, 5C, and 5D depict draw tools available to the user. As previously discussed, the project management tool includes drawing tools available to the user for making notations on the project plan or for sketching out a new plan of their own if one is not provided. Draw tools available in the palette include, but is not limited to: straight lines, free form lines, and dimension tools. By selecting each line type, the user is enabled to drag that type of line over the project floor plan. FIG. 5B illustrates how free form lines may be created around a room by dragging a finger over the surface of a mobile device screen. When the user has finished drawing, the line will be selectable via a bounding box, which may further be used to further refine the line by moving or stretching the line. Additionally, the box is selectable to reveal an action menu for the line, where the user may remove or adjust the visual features of the line. For example. The user may use the line properties popover to change the thickness or style of the line from full to dashed, including various line styles.

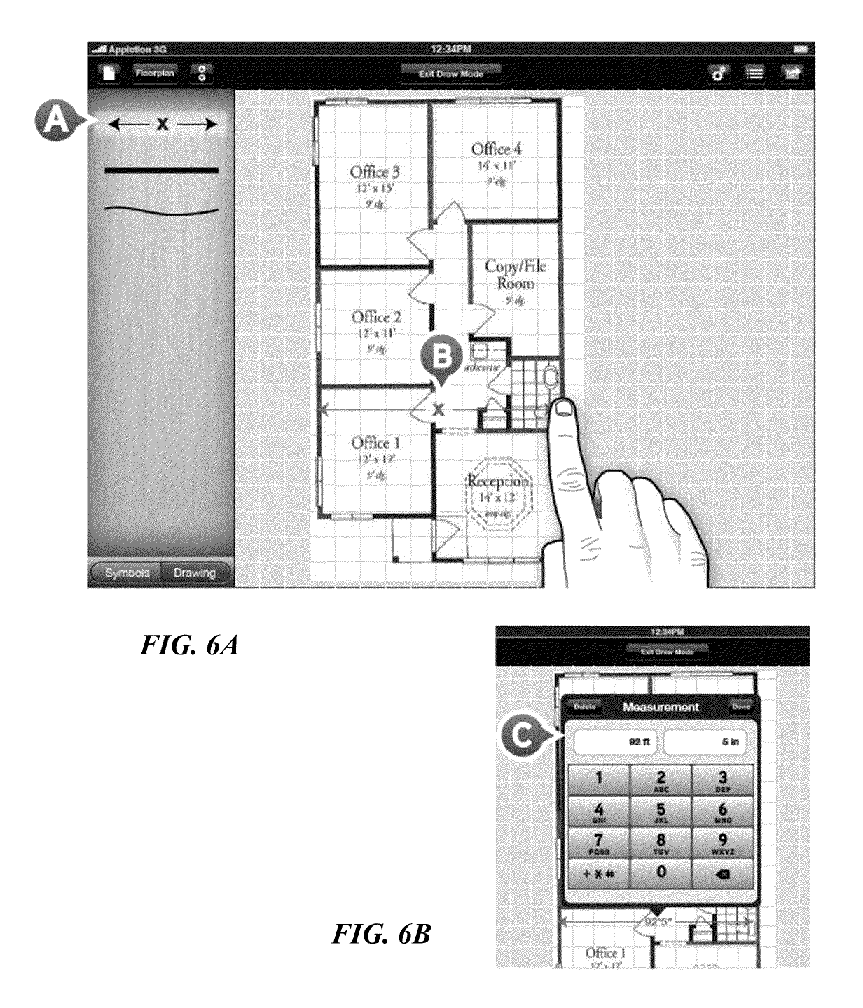

FIGS. 6A and 6B show exemplary general dimension tools that may be used to capture measurements and display them within the project floor plan. Multiple measurements may be made on the project floor plan to mark the length and width of individual rooms or for the whole floor. The dimension tool enables the user to drag a dimension indicator across the floor plan, which will appear along with a middle point indicator. Further, the user is able to input a numeric measurement of the dimension indicator currently drawn, using various commonly used system of units, including the metric or imperial unit system. These inputted numeric measurements may further be related to the provided background grids.

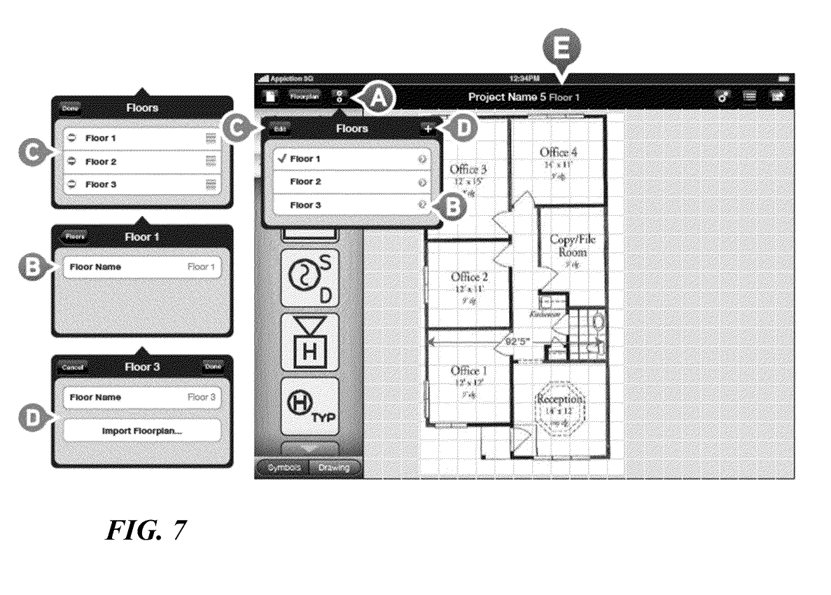

FIG. 7 shows an exemplary overlay on how project managers can handle multiple floors as previously discussed. By adding multiple floors within a property within the same project data file, the user is able to create and access as many floors as needed without the timely step of switching between projects. Each floor may be designated with its own distinguishing features, including floor names, particular order of the floor in relation to others, and ability to delete, rename, or reorder floors.

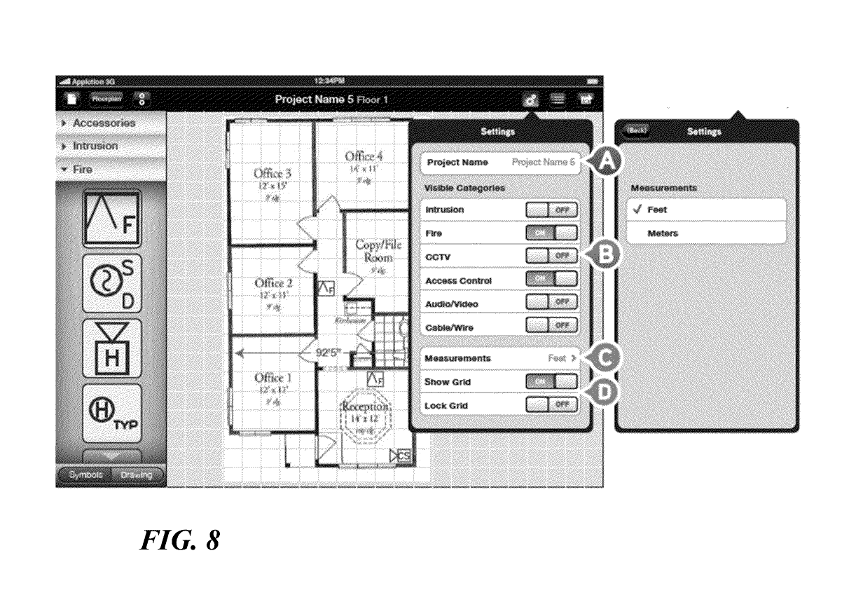

FIG. 8 depicts a management interface for creating settings of various project elements. The user has the capability to turn on or off the various categories of equipment. The symbols for each category may appear as a different color. As an exemplary embodiment, if fire symbols appear as red, CCTV symbols may appear as blue in color. In this way, if the user wishes to break down an estimate by particular categories, the user may select only the desired symbols to be displayed. By default, all categories will be toggled to be ON but may be toggled ON or OFF to hide or reveal specific categories of symbols at the user's will. Further, this will be reflected within the project floor plan and bid summary as well.

The management interface further comprises toggles for controlling the background grid. Users may benefit from using the grid to determine a sense of scale. However, they can turn the grid ON or OFF at will, as well as locking the grid in place. This gives the user flexibility to independently adjust the grid or not view it at all after grid units are set.

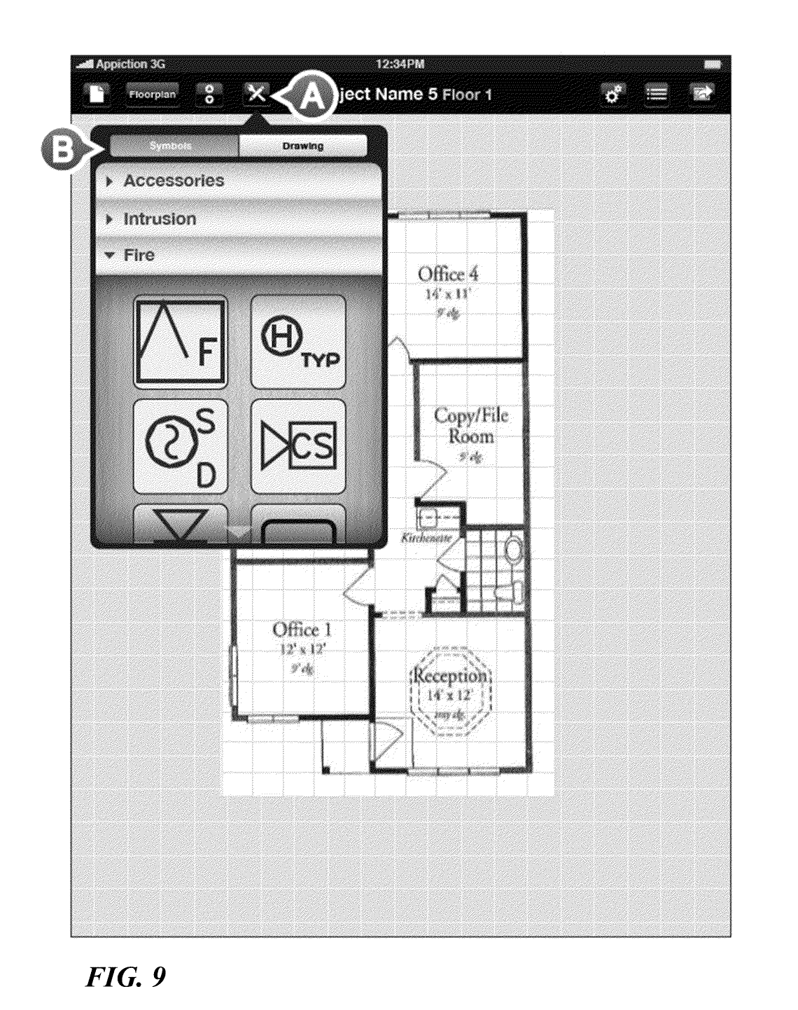

FIG. 9 illustrates another management capability of enabling various project views. Within mobile devices, there is often an issue of screen space. By having the present disclosure's popovers folded into options that may be accessed at the top of the screen, screen space is reserved for the task currently at hand. The user may used this segmented control to switch between symbol and draw tools, selecting symbols for inclusion into the floor plan and then the popover will automatically dismiss until selected again.

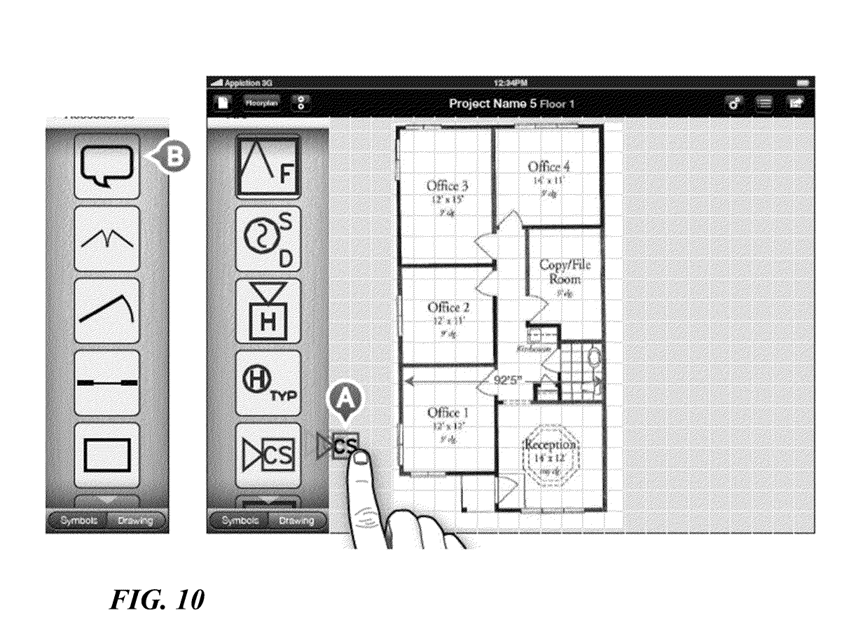

FIG. 10 shows exemplary symbols and accessories as taught within the current disclosure. The symbols represent low voltage equipment, while accessories are related to particular architectural features of the space. Both the symbols and accessories have the same attributes as being dragged and dropped directly from the popover into the project floor plan. As symbols and accessories are being added to the project floor plan, they are concurrently added to the bid summary sheet. Additionally, the user may instead of adding symbols or accessories, add a note to the project floor plan via a corresponding drag and drop icon. All of these added symbols, accessories, and text boxes will remain grounded in their fixed point, similar to the pins of a map depicting location.

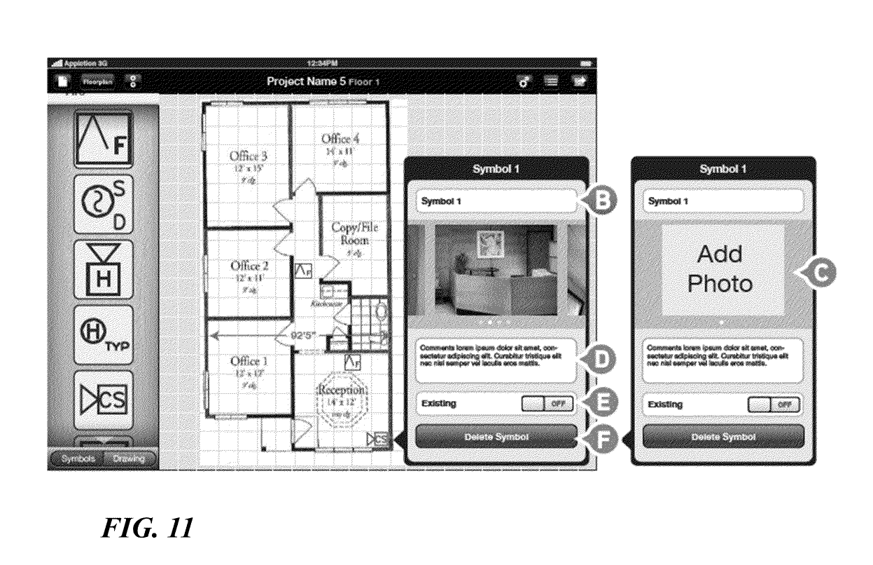

FIG. 11 depicts how annotations may be applied to various symbols. Annotations may be added to any symbol, accessory, or note previously placed on the project floor plan. Within this particular figure, the particular annotation added is a photo of the symbol.

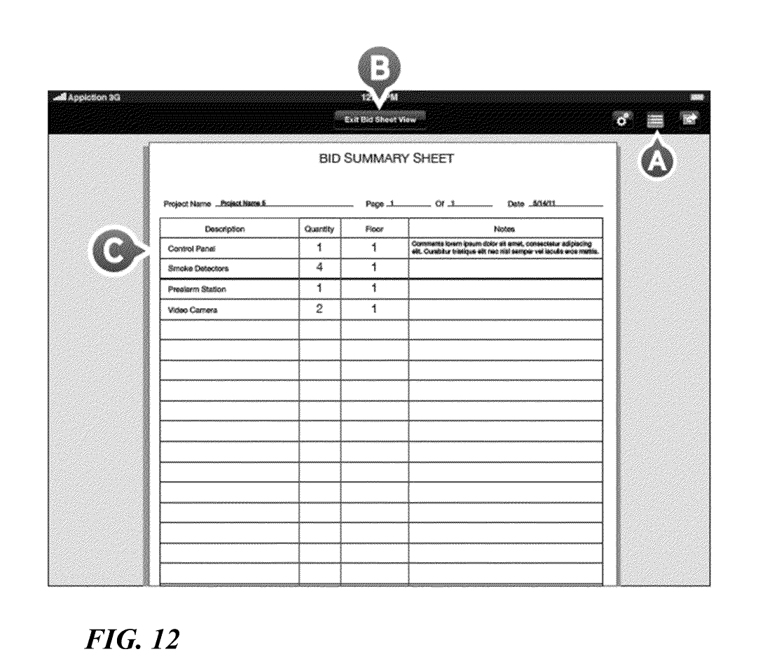

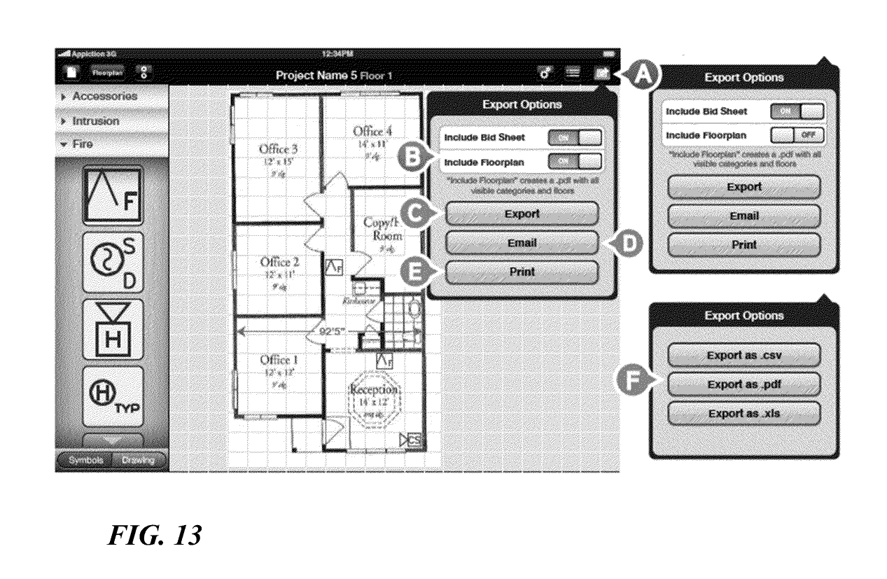

FIG. 12 illustrates a quick bid summary of the project, which is updated continuously as the user adds project elements to the project floor plan. Each line will list the name of the symbol, the amount of symbols used, the floor associated with that particular symbol, and any notes that were included with the symbol. If a symbol exists on multiple floors, the floors will be listed on the same line, but separated by commas. If multiple items of the same type include different notes, they will be listed individually. This, when combined with the floor plan, enables the user to quickly provide clients with proposals from the estimation process. FIG. 13 depicts the communication functionalities as taught within the current disclosure. The bid summary sheet, with all its descriptions, quantities, and notes may be exported along with the project floor plan for sharing with the client or contractors. Various exporting options are provided, including, but not limited to: exporting to electronic format, emailing, or printing, all in various formats such as CSV, PDF, XLS, 3D files, etc. This immediate export feature is one particular innovation which enables the estimation user to quickly convert an estimation process into a proposal, which may help to close the gap before sale and obtaining a contract for the project.

Additionally, the estimation tool may be integrated with an enterprise management system, either as a web application or software as a service tool. This enterprise management system may be used in conjunction with the estimation tool to provide corporate payment information and to configure mobile devices to utilizing the estimation tool. In this manner, users may access the system for onsite take-off and proposal delivery in order to complete the entire process of bidding, designing, tracking, and purchase of projects directly on-site at the client location.

The foregoing description of the preferred embodiments is provided to enable any person skilled in the art to make or use the described subject matter. Various modifications to these embodiments will be readily apparent to those skilled in the art, and the generic principles defined herein may be applied to other embodiments. Thus, the claimed subject matter is not intended to be limited to the embodiments shown herein but is to be accorded the widest scope consistent with the principles and novel features disclosed herein.

The detailed description set forth above in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

Further, although exemplary devices and schematics to implement the elements of the disclosed subject matter have been provided, one skilled in the art, using this disclosure, could develop additional hardware and/or software to practice the disclosed subject matter and each is intended to be included herein.

In addition to the above described embodiments, those skilled in the art will appreciate that this disclosure has application in a variety of arts and situations and this disclosure is intended to include the same. For example, this disclosure may be implemented in any of the following, but is not limited to: electrical, plumbing, or interior design applications.

What is claimed is:

1. A system, method, or tangible computer readable medium as described above.
